(19) United States
(12) Patent Application Publication
(10) Pub. No.: US 2005/0232848 A1
(43) Pub. Date: Oct. 20, 2005

(54) Packaging for dilute hypochlorite

(76) Inventors: Andreas Nguyen, Oakland, CA (US); Chih Chiang, Oakland, CA (US); William L. Smith, Oakland, CA (US); Kenneth L. Vieira, Oakland, CA (US)

Correspondence Address: THE CLOROX COMPANY, 1221 BROADWAY PO BOX 2351, OAKLAND, CA, 94623, US

(21) Appl. No.: 11/130,070

(22) Filed: May 16, 2005

Related U.S. Application Data
(63) Continuation-in-part of application No. 10/828,571, filed on Apr. 20, 2004.

(51) Int. Cl. C01B 11/04

(52) U.S. Cl. 423/473

(57) ABSTRACT

This invention relates to packaging for dilute hypochlorite and hypochlorous acid compositions to produce stable compositions. Container materials can be mulilayer with additives such as opacifiers, colorants, and UV inhibitors in the intermediate or outer layers. Additionally, labels with opacifiers, colorants, and UV inhibitors can improve stability. These compositions can be used to treat allergen containing surfaces, hard surfaces, food contact surfaces, hospital surfaces, food surfaces, kitchen surfaces, bathroom surfaces, human surfaces, animal surfaces, military equipment, transportation equipment, children's items, plant surfaces, seeds, outdoor surfaces, soft surfaces, air, wounds, and medical instruments.

### CROSS REFERENCE TO RELATED APPLICATIONS

The present application is a continuation-in-part of Co-pending application Ser. No. 10/828,571, filed Apr. 20, 2004, which is incorporated within.

### BACKGROUND OF THE INVENTION

1. Field of the Invention

This invention relates to packaging for dilute hypochlorite compositions, especially containers which hold dilute hypochlorite and hypochlorous acid compositions.

2. Description of the Related Art

U.S. Pat. Appl. 2002/0179884 to Hoshino et al. found that low concentration hypochlorite compositions present difficulties in obtaining a formulation with satisfactory storage stability. This is because loss of 100 ppm available chlorine in a 5% hypochlorite composition is usually not critical, but the same loss in a composition with 150 ppm available chlorine might be fatal. Hoshino lists several factors that affect the storage stability of dilute hypochlorite compositions, but offers no packaging solutions. U.S. Pat. No. 6,426,066 to Najafi et al. describes containers for oxidized water. Glass containers were preferred over HDPE or Teflon®.

U.S. Pat. No. 6,586,063 to Albanesi et al. describes stable multilayer containers for concentrated hypochlorite. The preferred outer layer for the container was PP or PET. The preferred inner layer was LDPE or LLDPE. The multilayer container could also be stabilized against permeation of hypochlorite by including a barrier layer of MDPE, HDPE, or EVOH. U.S. Pat. App. 2003/0186827 to Makansi describes an aerosol container for concentrated hypochlorite. The preferred inner liner for the container is polyethylene or polypropylene. U.S. Pat. No. 5,080,826 to Colborn et al. describes containers for fragranced concentrated hypochlorite. The preferred container material is HDPE for its molding properties, rather than for stability. Colburn mentions various other additives, such as colorants, opacifying agents, antioxidants, and plasticizing agents, but there is no concern about these additives for hypochlorite stability.

Based on the prior art examples, the need exists for containers for dilute hypochlorite that can give suitable storage stability. Various novel containers and container materials for hypohalous acid, hypohalous acid salt, and compositions containing these actives have been discovered.

### SUMMARY OF THE INVENTION

In accordance with the above objects and those that will be mentioned and will become apparent below, one aspect of the present invention is an article of commerce comprising:
a. a container; and
b. a composition, said composition comprising an oxidant selected from the group consisting of hypohalous acid, hypohalous acid salt, and combinations thereof,
c. wherein said composition has an available chlorine concentration of between 1.0 ppm to about 1200 ppm; and
d. wherein said container comprises a multilayer container comprising:
   i. an inner layer;
   ii. an outer layer;
   iii. an optional intermediate layer;
   iv. wherein at least one of said outer layer or said intermediate layer comprises an additive selected from the group consisting of opacifiers, colorants, UV inhibitors and combinations thereof; and
   v. wherein said inner layer comprises a substantially lower concentration of one of said additives compared to said outer layer or compared to said optional intermediate layer.

In accordance with the above objects and those that will be mentioned and will become apparent below, another aspect of the present invention comprises an article of commerce comprising:
a. a container;
b. a label; and
c. a composition, said composition comprising an oxidant selected from the group consisting of hypohalous acid, hypohalous acid salt, and combinations thereof,
d. wherein said composition has an available chlorine concentration of between 1.0 ppm to about 1200 ppm; and
e. wherein said label comprises an additive selected from the group consisting of an opacifier, a colorant, a UV inhibitor, and combinations thereof.

In accordance with the above objects and those that will be mentioned and will become apparent below, another aspect of the present invention comprises an article of commerce comprising:
a. a container; and
b. a composition,
c. wherein said composition has an available chlorine concentration of between 1.0 ppm to about 1200 ppm; and
d. wherein said container comprises a multilayer container comprising:
   i. an inner layer;
   ii. an outer layer;
   iii. an optional intermediate layer; and
e. wherein at least one of said outer layer or said intermediate layer comprises an additive selected from the group consisting of opacifiers, colorants, UV inhibitors and combinations thereof.

Further features and advantages of the present invention will become apparent to those of ordinary skill in the art in view of the detailed description of preferred embodiments below.

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone, not accounting for the substrate weight. Each of the noted cleaner composition components and substrates is discussed in detail below.

As used herein, the term “substrate” is intended to include any web, which is used to clean an article or a surface. Examples of cleaning sheets include, but are not limited to, mitts, webs of material containing a single sheet of material which is used to clean a surface by hand or a sheet of material which can be attached to a cleaning implement, such as a floor mop, handle, or a hand held cleaning tool, such as a toilet cleaning device.

As used herein, “wiping” refers to any shearing action that the substrate undergoes while in contact with a target surface. This includes hand or body motion, substrate-implement motion over a surface, or any perturbation of the substrate via energy sources such as ultrasound, mechanical vibration, electromagnetism, and so forth.

The term “cleaning composition”, as used herein, is meant to mean and include a cleaning formulation having at least one surfactant.

The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic, cationic and/or amphoteric agents.

Container Materials

The composition may be stored or shipped in a variety of containers, including glass, ABS, polycarbonate, high density polyethylene, low density polyethylene, linear low density polyethylene, blends of polyethylene, high density polypropylene, low density polypropylene, polyethylene terephthalate, or polyvinylchloride. A variety of additives may affect the stability of the composition. For instance, the density of the polyethylene resin may be modified by co-polymerizing with a small amount of a short chain alkylene, e.g., butene, hexene or octene.

The manufacture of thermoplastic parts by melt fabrication processes such as extrusion and molding is generally not possible using neat polymers directly as synthesized. Instead, it is common practice to “formulate” compositions containing a variety of ingredients in relatively small, but critical amounts. These ingredients may be categorized into two main and fairly distinct groups, namely product additives and processing aids. The product additives, which primarily serve the function of modifying the properties of the fabricated material, include pigments, such as titanium dioxide, and dyes (colorants), heat stabilizers and antioxidants, light and UV stabilizers, antistatic agents, slip and antiblocking agents, and the like. The processing aids primarily, if not exclusively, facilitate processing—often to the point that processing would be impossible without them. Foremost among these aids are lubricants, sometimes referred to as release agents, which prevent sticking of the hot molten thermoplastic polymer to fabrication surfaces such as extruder screws, extrusion dies, mill and calender rolls, injection molds, and the like. Lubricants are described in U.S. Pat. No. 4,925,890 to Leung et al. Antioxidants, UV absorbers and light stabilizers are described in U.S. Pat. No. 4,972,009 to Suhadolnik et al.

Various other additives include colorants, UV blockers, opacifying agents, and antioxidants, such as hindered phenols, e.g., BHT, Irganox 1010 (Ciba-Geigy A.G.), Irganox 1076 (Ciba-Geigy A.G.), Ionol (Shell Chemical Co.). Mold release agents and plasticizers can be added. The containers may have barrier films to increase storage stability. Suitable barrier films may include nylons, polyethylene terephthalate, fluorinated polyethylenes, and Barex (a copolymer of acrylonitrile and methylmethacrylate that is available from British Petroleum).

Labels may contain an opacifier, colorant, or UV inhibitor, for example, PCT App. WO0132411 to Cole et al. where the label adhesive contains a UV inhibitor.

Multilayer containers are preferred for compositions of the invention. Multilayer containers are described in PCT App. WO9601213 to Slat et al., PCT App. WO0238674 to Share et al., PCT App. WO0192007 to Barger et al., PCT App. WO0134479 to Serrano and references cited therein.

Containers

The composition may be delivered using a variety of delivery devices, including those described in Co-pending application Ser. No. 11/096,135, Packaging for Dilute Hypochlorite, filed Mar. 31, 2005 to Bitowft et al. The composition may be dispersed using an atomizer, a vaporizer, a nebulizer, a hose with laser created slits, or a spray device. The composition may be delivered on a continuous basis, such as with a humidifier. The composition may be delivered on a pulsed basis, such as with a canister on a timer. One spray device is an electrostatic sprayer, as described in PCT App. WO972883 to Fox et al.. The composition may be applied to skin surfaces. The composition may be delivered from a variety of containers, such as a dual chambered bottle, a trigger spray bottle, an aerosol canister, and a bleach pen.

Dual Delivery Container

Alternatively, such liquid formulations may be provided as a dual container delivery system comprising a first container containing a first aqueous solution comprising the hypohalite or a source thereof, a second container containing a second aqueous solution comprising additional agents, and delivery means for delivering the first and second solutions to a surface such that the hypohalite and agents are admixed just before or upon impacting the surface. This dual container kind of embodiment could be realised merely by providing the two solutions in respective separate containers. The consumer could then apply each to the surface, either sequentially or simultaneously. However, it is more convenient to provide the products in a dual-compartment container in which the aqueous solutions are stored in separate compartments. The delivery means then allows them to be delivered to the surface as they are exiting the delivery means and/or in mid-air as they are directed to the surface and/or on the surface itself. Preferably, they are delivered to be mixed in approximately equal volumes, i.e. typically from 0.5:1 v/v to 1:0.5 v/v. A particularly preferred delivery means, either from a single compartment or a dual compartment container, is a trigger spray head. In the case of a dual compartment system, this will preferably have two siphon tubes, respectively leading into each compartment and either a single nozzle with a mixing chamber or two separate nozzles substantially adjacent to each other. If desired, a dispensing nozzle or nozzles configured to promote foaming may be used.

Hypohalous Acid and Salts

Suitable hypohalous acids and salts may be provided by a variety of sources, including oxidized water; hypohalous acid, hypohalous acid salt, hypohalous acid generating species, hypohalous acid salt generating species; as well as compositions that are organic based sources of halides, such as chloroisocyanurates, haloamines, haloimines, haloimides and haloamides, or mixtures thereof. These compositions may also produce hypohalous acid or hypohalite species in situ. Suitable hypohalous acids and salts for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chlorosulfamide, N-chloroamines, chlorohydantoins such as dichlorodimethyl hydantoin and chlorobromo dimethylhydantoin, bromo-compounds corresponding to the chloro-compounds above, and compositions which generate the corresponding hypohalous acids, or mixtures thereof.

In one embodiment wherein the compositions herein are liquid, said hypohalite composition comprises an alkali metal and/or alkaline earth metal hypochlorite, or mixtures thereof. Compositions may comprise an alkali metal and/or alkaline earth metal hypochlorite selected from the group consisting of sodium hypochlorite, potassium hypochlorite, magnesium hypochlorite, lithium hypochlorite and calcium hypochlorite, and mixtures thereof. Oxidized water, containing low available chlorine concentrations can be produced by the electrolysis of an aqueous saline solution as described in U.S. App. 2002/0182262 Selkon.

The hypohalous acids and salt composition may be an equilibrium mixture of hypochlorous acid and sodium hypochlorite. The active species is present in an amount from above zero to about 15 weight percent of the composition, or from about 0.001 weight percent (10 ppm) to about 10 weight percent of the composition, or from about 0.005 (50 ppm) to about 5 weight percent of the composition.

The amount of available halogen oxidant in the composition is determined by placing samples of the composition into about 50 milliliters of distilled water, followed by addition of about 10 milliliters of a 10 weight/weight percent solution of potassium iodide and addition of about 10 milliliters of a 10 volume percent solution of sulfuric acid, the resulting mixture being well stirred. The resulting yellow to brown solution, whose color is the result of oxidation of free iodide ion (I⁻) to molecular iodine (I₂), was then volumetrically titrated to an essentially colorless endpoint by addition of standardized 0.1 Molar sodium thiosulfate (Na₂S₂O₃) titrant. Calculation then expresses the result as percent of available molecular chlorine (Cl₂), that is to say assigning two equivalents per mole of titrated hypohalite oxidant. Stability results are then expressed by repeated assays over time using identically prepared samples resulting from the same composition, normalized to 100 percent representative of the starting available chlorine measured initially.

Surfactants

The composition of the invention may contain surfactants. The surfactants should be stable to hypohalous acid or hypohalous acid salt if long term storage is desired. If the solutions of the composition are generated prior to use, then surfactants having less stability may be used. Examples of surfactants having relatively good stability can be found in U.S. Pat. Nos. 6,413,925 and 5,851,421.

The composition may contain one or more surfactants selected from anionic, nonionic, cationic, ampholytic, amphoteric and zwitterionic surfactants and mixtures thereof. A typical listing of anionic, nonionic, ampholytic, and zwitterionic classes, and species of these surfactants, is given in U.S. Pat. No. 3,929,678 to Laughlin and Heuring. A list of suitable cationic surfactants is given in U.S. Pat. No. 4,259,217 to Murphy. Where present, ampholytic, amphoteric and zwitteronic surfactants are generally used in combination with one or more anionic and/or nonionic surfactants. The surfactants may be present at a level of from about 0% to 90%, or from about 0.001% to 50%, or from about 0.01% to 25% by weight.

The composition may comprise an anionic surfactant. Essentially any anionic surfactants useful for detersive purposes can be comprised in the cleaning composition. These can include salts (including, for example, sodium, potassium, ammonium, and substituted ammonium salts such as mono-, di- and tri-ethanolamine salts) of the anionic sulfate, sulfonate, carboxylate and sarcosinate surfactants. Anionic surfactants may comprise a sulfonate or a sulfate surfactant. Anionic surfactants may comprise an alkyl sulfate, a linear or branched alkyl benzene sulfonate, or an alkyldiphenyloxide disulfonate, as described herein.

Other anionic surfactants include the isethionates such as the acyl isethionates, N-acyl taurates, fatty acid amides of methyl tauride, alkyl succinates and sulfosuccinates, monoesters of sulfosuccinate (for instance, saturated and unsaturated C12-C18 monoesters) diesters of sulfosuccinate (for instance saturated and unsaturated C6-C14 diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C5-C17 acyl-N-(C1-C4 alkyl) and —N-(C1-C2 hydroxyalkyl) glucamine sulfates, and sulfates of alkylpolysacchanides such as the sulfates of alkylpolyglucoside (the nonionic nonsulfated compounds being described herein). Alkyl sulfate surfactants may be selected from the linear and branched primary C10-C18 alkyl sulfates, the C11-C15 branched chain alkyl sulfates, or the C12-C14 linear chain alkyl sulfates.

Alkyl ethoxysulfate surfactants may be selected from the group consisting of the C10-C18 alkyl sulfates which have been ethoxylated with from 0.5 to 20 moles of ethylene oxide per molecule. The alkyl ethoxysulfate surfactant may be a C11-C18, or a C11-C15 alkyl sulfate which has been ethoxylated with from 0.5 to 7, or from 1 to 5, moles of ethylene oxide per molecule. One aspect of the invention employs mixtures of the alkyl sulfate and/ or sulfonate and alkyl ethoxysulfate surfactants. Such mixtures have been disclosed in PCT Patent Application No. WO 93/18124.

Anionic sulfonate surfactants suitable for use herein include the salts of C5-C20 linear alkylbenzene sulfonates, alkyl ester sulfonates, C6-C22 primary or secondary alkane sulfonates, C6-C24 olefin sulfonates, sulfonated polycarboxylic acids, alkyl glycerol sulfonates, fatty acyl glycerol sulfonates, fatty oleyl glycerol sulfonates, and any mixtures thereof. Suitable anionic carboxylate surfactants include the alkyl ethoxy carboxylates, the alkyl polyethoxy polycarboxylate surfactants and the soaps (‘alkyl carboxyls’), especially certain secondary soaps as described herein. Suitable alkyl ethoxy carboxylates include those with the formula RO(CH₂CH₂O)ₓCH₂COO⁻M⁺ wherein R is a C6 to C18 alkyl group, x ranges from 0 to 10, and the ethoxylate distribution is such that, on a weight basis, the amount of material where x is 0 is less than 20% and M is a cation. Suitable alkyl polyethoxypolycarboxylate surfactants include those having the formula RO—(CHR¹—CHR²—O)—R³ wherein R is a C6 to C18 alkyl group, x is from 1 to 25, R¹ and R² are selected from the group consisting of hydrogen, methyl acid radical, succinic acid radical, hydroxysuccinic acid radical, and mixtures thereof, and R³ is selected from the group consisting of hydrogen, substituted or unsubstituted hydrocarbon having between 1 and 8 carbon atoms, and mixtures thereof.

Suitable soap surfactants include the linear saturated soaps, such as lauric acid. Also suitable are secondary soap surfactants, which contain a carboxyl unit connected to a secondary carbon. Suitable secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressors.

Other suitable anionic surfactants are the alkali metal sarcosinates. Examples are the myristyl and oleoyl methyl sarcosinates in the form of their sodium salts.

Essentially any alkoxylated nonionic surfactants are suitable herein, for instance, ethoxylated and propoxylated nonionic surfactants. Nonionic surfactants with stability to hypohalous acid or hypohalous acid salt, such as capped nonionics, are especially suitable. Alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ ethylene diamine adducts.

The condensation products of aliphatic alcohols with from 1 to 25 moles of alkylene oxide, particularly ethylene oxide and/or propylene oxide, are suitable for use herein. The alkyl chain of the aliphatic alcohol can either be straight or branched, primary or secondary, and generally contains from 6 to 22 carbon atoms. Also suitable are the condensation products of alcohols having an alkyl group containing from 8 to 20 carbon atoms with from 2 to 10 moles of ethylene oxide per mole of alcohol.

Polyhydroxy fatty acid amides suitable for use herein are those having the structural formula R²CONR¹Z wherein: R¹ is H, C1-C4 hydrocarbyl, 2-hydroxyethyl, 2-hydroxypropyl, ethoxy, propoxy, or a mixture thereof, for instance, C1-C4 alkyl, or C1 or C2 alkyl; and R² is a C5-C31 hydrocarbyl, for instance, straight-chain C5-C19 alkyl or alkenyl, or straight-chain C9-C 17 alkyl or alkenyl, or straight-chain C11-C17 alkyl or alkenyl, or mixture thereof-, and Z is a polyhydroxyhydrocarbyl having a linear hydrocarbyl chain with at least 3 hydroxyls directly connected to the chain, or an alkoxylated derivative (for example, ethoxylated or propoxylated) thereof. Z may be derived from a reducing sugar in a reductive amination reaction, for example, when Z is a glycityl.

Suitable fatty acid amide surfactants include those having the formula: R¹CON(R²)₂ wherein R¹ is an alkyl group containing from 7 to 21, or from 9 to 17 carbon atoms and each R² is selected from the group consisting of hydrogen, C1-C4 alkyl, C1-C4 hydroxyalkyl, and —(C₂H₄O)ₓH, where x is in the range of from 1 to 3.

Suitable alkylpolysaccharides for use herein are disclosed in U.S. Pat. No. 4,565,647 to Llenado, having a hydrophobic group containing from 6 to 30 carbon atoms and a polysaccharide, e.g., a polyglycoside, hydrophilic group containing from 1.3 to 10 saccharide units. Alkylpolyglycosides may have the formula: R²O(CₙH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl may be derived from glucose.

Suitable amphoteric surfactants for use herein include the amine oxide surfactants and the alkyl amphocarboxylic acids. Suitable amine oxides include those compounds having the formula R³(OR⁴)ₓNO(R⁵)₂ wherein R³ is selected from an alkyl, hydroxyalkyl, acylamidopropyl and alkylphenyl group, or mixtures thereof, containing from 8 to 26 carbon atoms; R⁴ is an alkylene or hydroxyalkylene group containing from 2 to 3 carbon atoms, or mixtures thereof, x is from 0 to 5, preferably from 0 to 3; and each R⁵ is an alkyl or hydroxyalkyl group containing from 1 to 3, or a polyethylene oxide group containing from 1 to 3 ethylene oxide groups. Suitable amine oxides are C10-C18 alkyl dimethylamine oxide, and C10-18 acylamido alkyl dimethylamine oxide. A suitable example of an alkyl amphodicarboxylic acid is Miranol(™) C2M Conc. manufactured by Miranol, Inc., Dayton, N.J.

Zwitterionic surfactants can also be incorporated into the cleaning compositions. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwittenionic surfactants for use herein.

Suitable betaines are those compounds having the formula R(R¹)₂N⁺R²COO⁻ wherein R is a C6-C18 hydrocarbyl group, each R¹ is typically C1-C3 alkyl, and R² is a C1-C5 hydrocarbyl group. Suitable betaines are C12-18 dimethyl-ammonio hexanoate and the C10-18 acylamidopropane (or ethane) dimethyl (or diethyl) betaines. Complex betaine surfactants are also suitable for use herein.

Suitable cationic surfactants to be used herein include the quaternary ammonium surfactants. The quaternary ammonium surfactant may be a mono C6-C16, or a C6-C10 N-alkyl or alkenyl ammonium surfactant wherein the remaining N positions are substituted by methyl, hydroxyethyl or hydroxypropyl groups. Suitable are also the mono-alkoxylated and bis-alkoxylated amine surfactants.

Another suitable group of cationic surfactants, which can be used in the cleaning compositions, are cationic ester surfactants. The cationic ester surfactant is a compound having surfactant properties comprising at least one ester (i.e. —COO—) linkage and at least one cationically charged group. Suitable cationic ester surfactants, including choline ester surfactants, have for example been disclosed in U.S. Pat. Nos. 4,228,042, 4,239,660 and 4,260,529. The ester linkage and cationically charged group may be separated from each other in the surfactant molecule by a spacer group consisting of a chain comprising at least three atoms (i.e. of three atoms chain length), or from three to eight atoms, or from three to five atoms, or three atoms. The atoms forming the spacer group chain are selected from the group consisting, of carbon, nitrogen and oxygen atoms and any mixtures thereof, with the proviso that any nitrogen or oxygen atom in said chain connects only with carbon atoms in the chain. Thus spacer groups having, for example, —O—O— (i.e. peroxide), —N—N—, and —N—O— linkages are excluded, whilst spacer groups having, for example —CH₂—O—, CH₂— and —CH₂—NH—CH₂— linkages are included. The spacer group chain may comprise only carbon atoms, or the chain is a hydrocarbyl chain.

The composition may comprise cationic mono-alkoxylated amine surfactants, for instance, of the general formula: R¹R²R³N⁺ApR⁴ X⁻ wherein R¹ is an alkyl or alkenyl moiety containing from about 6 to about 18 carbon atoms, or from 6 to about 16 carbon atoms, or from about 6 to about 14 carbon atoms; R² and R³ are each independently alkyl groups containing from one to about three carbon atoms, for instance, methyl, for instance, both R² and R³ are methyl groups; R⁴ is selected from hydrogen, methyl and ethyl; X⁻ is an anion such as chloride, bromide, methylsulfate, sulfate, or the like, to provide electrical neutrality; A is a alkoxy group, especially a ethoxy, propoxy or butoxy group; and p is from 0 to about 30, or from 2 to about 15, or from 2 to about 8. The ApR⁴ group in the formula may have p=1 and is a hydroxyalkyl group, having no greater than 6 carbon atoms whereby the —OH group is separated from the quaternary ammonium nitrogen atom by no more than 3 carbon atoms. Suitable ApR⁴ groups are —CH₂CH₂—OH, —CH₂CH₂CH₂—OH, —CH₂CH(CH₃)—OH and —CH(CH₃)CH₂—OH. Suitable R¹ groups are linear alkyl groups, for instance, linear R¹ groups having from 8 to 14 carbon atoms.

Suitable cationic mono-alkoxylated amine surfactants for use herein are of the formula R¹(CH₃)(CH₃)N⁺(CH₂CH₂O)₂₋₅H X⁻ wherein R¹ is C10-C18 hydrocarbyl and mixtures thereof, especially C10-C14 alkyl, or C10 and C12 alkyl, and X is any convenient anion to provide charge balance, for instance, chloride or bromide.

As noted, compounds of the foregoing type include those wherein the ethoxy (CH₂CH₂O) units (EO) are replaced by butoxy, isopropoxy [CH(CH₃)CH₂O] and [CH₂CH(CH₃)O] units (i-Pr) or n-propoxy units (Pr), or mixtures of EO and/or Pr and/or i-Pr units.

The cationic bis-alkoxylated amine surfactant may have the general formula: R¹R²N⁺ApR³A′qR⁴ X⁻ wherein R¹ is an alkyl or alkenyl moiety containing from about 8 to about 18 carbon atoms, or from 10 to about 16 carbon atoms, or from about 10 to about 14 carbon atoms; R² is an alkyl group containing from one to three carbon atoms, for instance, methyl; R³ and R⁴ can vary independently and are selected from hydrogen, methyl and ethyl, X⁻ is an anion such as chloride, bromide, methylsulfate, sulfate, or the like, sufficient to provide electrical neutrality. A and A′ can vary independently and are each selected from C1-C4 alkoxy, for instance, ethoxy, (i.e., —CH₂CH₂O—), propoxy, butoxy and mixtures thereof, p is from 1 to about 30, or from 1 to about 4 and q is from 1 to about 30, or from 1 to about 4, or both p and q are 1.

Suitable cationic bis-alkoxylated amine surfactants for use herein are of the formula R¹CH₃N⁺(CH₂CH₂OH)(CH₂CH₂OH) X⁻, wherein R¹ is C10-C18 hydrocarbyl and mixtures thereof, or C10, C12, C14 alkyl and mixtures thereof, X⁻ is any convenient anion to provide charge balance, for example, chloride. With reference to the general cationic bis-alkoxylated amine structure noted above, since in one example compound R¹ is derived from (coconut) C12-C14 alkyl fraction fatty acids, R² is methyl and ApR³ and A′qR⁴ are each monoethoxy.

Other cationic bis-alkoxylated amine surfactants useful herein include compounds of the formula: R¹R²N⁺—(CH₂CH₂O)ₚH—(CH₂CH₂O)_{q}H X⁻ wherein R¹ is C10-C18 hydrocarbyl, or C10-C14 alkyl, independently p is 1 to about 3 and q is 1 to about 3, R² is C1-C3 alkyl, for example, methyl, and X⁻ is an anion, for example, chloride or bromide.

Other compounds of the foregoing type include those wherein the ethoxy (CH₂CH₂O) units (EO) are replaced by butoxy (Bu) isopropoxy [CH(CH₃)CH₂O] and [CH₂CH(CH₃)O] units (i-Pr) or n-propoxy units (Pr), or mixtures of EO and/or Pr and/or i-Pr units.

The inventive compositions may include at least one fluorosurfactant selected from nonionic fluorosurfactants, cationic fluorosurfactants, and mixtures thereof which are soluble or dispersible in the aqueous compositions being taught herein, sometimes compositions which do not include further detersive surfactants, or further organic solvents, or both. Suitable nonionic fluorosurfactant compounds are found among the materials presently commercially marketed under the tradename Fluorad® (ex. 3M Corp.) Exemplary fluorosurfactants include those sold as Fluorad® FC-740, generally described to be fluorinated alkyl esters; Fluorad® FC-430, generally described to be fluorinated alkyl esters; Fluorad® FC-431, generally described to be fluorinated alkyl esters; and, Fluorad® FC-170-C, which is generally described as being fluorinated alkyl polyoxyethylene ethanols.

Suitable nonionic fluorosurfactant compounds include those which is believed to conform to the following formulation: CₙF₂ₙ₊₁SO₂N(C₂H₅)(CH₂CH₂O)ₓCH₃ wherein: n has a value of from 1-12, or from 4-12, or 8; x has a value of from 4-18, or from 4-10, or 7; which is described to be a nonionic fluorinated alkyl alkoxylate and which is sold as Fluorad® FC-171 (ex. 3M Corp., formerly Minnesota Mining and Manufacturing Co.).

Additionally suitable nonionic fluorosurfactant compounds are also found among the materials marketed under the tradename ZONYL® (DuPont Performance Chemicals). These include, for example, ZONYL® FSO and ZONYL® FSN. These compounds have the following formula: RfCH₂CH₂O(CH₂CH₂O)ₓH where Rf is F(CF₂CF₂)_{y}. For ZONYL® FSO, x is 0 to about 15 and y is 1 to about 7. For ZONYL® FSN, x is 0 to about 25 and y is 1 to about 9.

An example of a suitable cationic fluorosurfactant compound has the following structure: CₙF₂ₙ₊₁SO₂NHC₃H₆N⁺(CH₃)₃I⁻ where n˜8. This cationic fluorosurfactant is available under the tradename Fluorad® FC-135 from 3M. Another example of a suitable cationic fluorosurfactant is F₃—(CF₂)ₙ— (CH₂)ₘSCH₂CHOH—CH₂—N⁺R₁R₂R₃ Cl⁻ wherein: n is 5-9 and m is 2, and R₁, R₂ and R₃ are —CH₃. This cationic fluorosurfactant is available under the tradename ZONYL® FSD (available from DuPont, described as 2-hydroxy-3-((gamma-omega-perfluoro-C₆₋₂₀-alkyl)thio)-N,N,N-trimethyl-1-propyl ammonium chloride). Other cationic fluorosurfactants suitable for use in the present invention are also described in EP 866,115 to Leach and Niwata.

The fluorosurfactant selected from the group of nonionic fluorosurfactant, cationic fluorosurfactant, and mixtures thereof may be present in amounts of from 0.001 to 5% wt., preferably from 0.01 to 1% wt., and more preferably from 0.01 to 0.5% wt.

Solvent

The composition of the invention may contain solvents. The solvents should be stable to hypohalous acid or hypohalous acid salt if long term storage is desired. If the solutions of the composition are generated prior to use, then solvents having less stability may be used.

Suitable organic solvents include, but are not limited to, C₁₋₆ alkanols, C₁₋₆ diols, C₁₋₁₀ alkyl ethers of alkylene glycols, C₃₋₂₄ alkylene glycol ethers, polyalkylene glycols, short chain carboxylic acids, short chain esters, isoparafinic hydrocarbons, mineral spirits, alkylaromatics, terpenes, terpene derivatives, terpenoids, terpenoid derivatives, formaldehyde, and pyrrolidones. Alkanols include, but are not limited to, methanol, ethanol, n-propanol, isopropanol, butanol, pentanol, and hexanol, and isomers thereof. Diols include, but are not limited to, methylene, ethylene, propylene and butylene glycols. Alkylene glycol ethers include, but are not limited to, ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Short chain carboxylic acids include, but are not limited to, acetic acid, glycolic acid, lactic acid and propionic acid. Short chain esters include, but are not limited to, glycol acetate, and cyclic or linear volatile methylsiloxanes. Water insoluble solvents such as isoparafinic hydrocarbons, mineral spirits, alkylaromatics, terpenoids, terpenoid derivatives, terpenes, and terpenes derivatives can be mixed with a water-soluble solvent when employed.

Examples of organic solvent having a vapor pressure less than 0.1 mm Hg (20° C.) include, but are not limited to, dipropylene glycol n-propyl ether, dipropylene glycol t-butyl ether, dipropylene glycol n-butyl ether, tripropylene glycol methyl ether, tripropylene glycol n-butyl ether, diethylene glycol propyl ether, diethylene glycol butyl ether, dipropylene glycol methyl ether acetate, diethylene glycol ethyl ether acetate, and diethylene glycol butyl ether acetate (all available from ARCO Chemical Company).

The solvents can be present at a level of from 0.001% to 10%, or from 0.01% to 10%, or from 1% to 4% by weight.

Additional Adjuncts

The compositions optionally contain one or more of the following adjuncts: stain and soil repellants, lubricants, odor control agents, perfumes, fragrances and fragrance release agents, brighteners, and fluorescent whitening agents. Other adjuncts include, but are not limited to, acids, electrolytes, dyes and/or colorants, solubilizing materials, stabilizers, thickeners, defoamers, hydrotropes, cloud point modifiers, preservatives, and other polymers. The solubilizing materials, when used, include, but are not limited to, hydrotropes (e.g. water soluble salts of low molecular weight organic acids such as the sodium and/or potassium salts of toluene, cumene, and xylene sulfonic acid). The acids, when used, include, but are not limited to, mineral acids, organic hydroxy acids, citric acids, keto acid, and the like. Electrolytes, when used, include, calcium, sodium and potassium chloride. Thickeners, when used, include, but are not limited to, polyacrylic acid, xanthan gum, calcium carbonate, aluminum oxide, alginates, guar gum, methyl, ethyl, clays, and/or propyl hydroxycelluloses. Defoamers, when used, include, but are not limited to, silicones, aminosilicones, silicone blends, and/or silicone/ hydrocarbon blends.

Preservatives, when used, include, but are not limited to, mildewstat or bacteriostat, methyl, ethyl and propyl parabens, phosphates such as trisodium phosphate, short chain organic acids (e.g. acetic, lactic and/or glycolic acids), bisguanidine compounds (e.g. Dantagard and/or Glydant) and/or short chain alcohols (e.g. ethanol and/or IPA). The mildewstat or bacteriostat includes, but is not limited to, mildewstats (including non-isothiazolone compounds) including Kathon GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL, a 2-bromo-2-nitropropane 1,3 diol, from Boots Company Ltd., PROXEL CRL, a propyl-p-hydroxybenzoate, from ICI PLC; NIPASOL M, an o-phenyl-phenol, Na⁺ salt, from Nipa Laboratories Ltd., DOWICIDE A, a 1,2-Benzoisothiazolin-3-one, from Dow Chemical Co., Nipacides from Clariant, and IRGASAN DP 200, a 2,4,4′-trichloro-2-hydroxydiphenylether, from Ciba-Geigy A.G.

Antimicrobial Agent

The composition of the invention may contain antimicrobial agents. The antimicrobial agents should be stable to hypohalous acid or hypohalous acid salt if long term storage is desired. If the solutions of the composition are generated prior to use, then antimicrobial agents having less stability may be used.

Antimicrobial agents include quaternary ammonium compounds and phenolics. Non-limiting examples of these quaternary compounds include benzalkonium chlorides and/or substituted benzalkonium chlorides, di(C₆-C₁₄)alkyl di short chain (C₁₋₄ alkyl and/or hydroxyalkyl) quaternary ammonium salts, N-(3-chloroallyl) hexammonium chlorides, benzethonium chloride, methylbenzethonium chloride, and cetylpyridinium chloride. Other quaternary compounds include the group consisting of dialkyldimethyl ammonium chlorides, alkyl dimethylbenzyl ammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophenyl biguanide) and its salts are also in this class.

Builder/Buffer

The composition of the invention may contain a builder or buffer. The builder or buffer should be stable to hypohalous acid or hypohalous acid salt if long term storage is desired. If the solutions of the composition are generated prior to use, then builders or buffers having less stability may be used.

The composition may include a builder or buffer, which can be used as a pH adjusting agent or as a sequestering agent in the composition. A variety of builders or buffers can be used and they include, but are not limited to, phosphate-silicate compounds, carbon dioxide or carbonate, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Builders or buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builders or buffers can also exist either partially or totally in the protonated or neutralized form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2-methylpropanol. Preferred buffering agents for compositions of this invention are nitrogen-containing materials. Some examples are amino acids such as lysine or lower alcohol amines like mono-, di-, and triethanolamine. Other preferred nitrogen-containing buffering agents are tri(hydroxymethyl) amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol, N,N′-tetra-methyl-1,3-diamino-2-propanol, N,N-bis(2-hydroxyethyl)glycine (bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see WO 95/07971, which is incorporated herein by reference. Other preferred pH adjusting agents include sodium or potassium hydroxide.

When employed, the builder, buffer, or pH adjusting agent comprises at least about 0.001% and typically about 0.01-5% of the cleaning composition. Preferably, the builder or buffer content is about 0.01-2%.

Fragrance

The composition of the invention may contain fragrance. The fragrance should be stable to hypohalous acid or hypohalous acid salt if long term storage is desired. If the solutions of the composition are generated prior to use, then fragrances having less stability may be used.

Compositions of the present invention may comprise from about 0.001% to about 5% by weight of the fragrance. Compositions of the present invention may comprise from about 0.005% to about 2.5% by weight of the fragrance. Compositions of the present invention may comprise from about 0.01% to about 1% by weight of the fragrance.

Water and pH

The water should be present at a level of less than about 99.999%. The water may be deionized, filtered to remove impurities including metals and organic carbon, purified by reverse osmosis, purified by distillation, or any combination thereof. Purified water may be prepared by a process selected from the group consisting of sodium cation exchange, hydrogen cation exchange, reverse osmosis, activated carbon treatment, UV light treatment, UVC, ozone treatment, chlorination, ultrafiltration, nanofiltration, electrodialysis, and a combination thereof. During preparation there may be a need for hygiene and segregation to prevent the introduction of compounds that are oxidized by hypochlorite since these become more important at low concentrations where the loss of a few ppm may be significant.

The composition may be adjusted for pH using a pH adjusting agent. Suitable pH adjusting agents include carbon dioxide, alkali metal carbonate, alkali metal bicarbonate, alkali metal silicates, alkali metal hydroxide, alkali phosphate salt, alkaline earth phosphate salt, alkali borate salt, hydrochloric acid, nitric acid, sulfuric acid, alkali metal hydrogen sulfate, acetic acid, vinegar from various sources, other carboxylic acids, polycarboxylates, organic sulfonic acids, sulfamic acid, amine, alkyl amine, dialkyl amine, and trialkyl amine. The composition may have a pH from 1 to 13. The composition may have a pH from 2 to 12. The composition may have a pH from 2 to 5. The composition may have a pH from 5 to 8. The composition may have a pH from 6 to 8. The composition may have a pH from 5 to 6. The composition may have a pH from 6 to 7.5. The composition may have a pH from 9 to 13. The composition may have a pH from 10 to 12.5. The composition may have a pH from 12 to 13.

Method of Use

The composition may be dispersed into the air.

The composition may be applied to soft surfaces including clothing, bedding, upholstery, curtains, and carpets. The composition may be applied to soft surfaces by spraying, by wiping, by direct application, by immersion, or as part of the laundry washing process.

The composition may be applied to hard surfaces including kitchen surfaces, bathroom surfaces, walls, floors, outdoor surfaces, automobiles, countertops, food contact surfaces, toys, food products including fruits and vegetables. The composition may be applied to hard surfaces by spraying, by wiping, by direct application, by immersion, or as part of the normal cleaning process.

The composition may be applied on human and animal surfaces, including external skin areas and internal cavities. The composition may have low skin sensitivity and may be appropriate to be taken orally or by inhalation. The composition may be applied to human and animal surfaces by spraying, by wiping, by direct application, by immersion, or as part of the normal treatment process. The compositon may be applied as a thickened gel. The composition may be applied using a device to direct its application, such as a bleach pen. The composition may be applied as a wound dressing.

The composition may be applied with a nonwoven substrate, wipe or cleaning pad on inanimate, household surfaces, including floors, counter tops, furniture, windows, walls, and automobiles. The composition may be applied to baby and children's items, including toys, bottles, pacifiers, etc. The composition may be applied with a nonwoven substrate, brush, sponge, wipe or cleaning pad on human and animal surfaces, including external skin areas and internal cavities. Other surfaces include stainless steel, chrome, and shower enclosures. The nonwoven substrate, wipe or cleaning pad can be packaged individually or together in canisters, tubs, etc. The nonwoven substrate, wipe or cleaning pad can be used with the hand, or as part of a cleaning implement attached to a tool or motorized tool, such as one having a handle. Examples of tools using a nonwoven substrate, wipe or pad include U.S. Pat. No. 6,611,986 to Seals, WO00/71012 to Belt et al., U.S. Pat. App. 2002/0129835 to Pieroni and Foley, and WO00/27271 to Policicchio et al.

For certain uses, for example, for human and animal surfaces, the composition may be thickened. The composition may be thickened using surfactant thickening, polymer thickening, or other means. Thickening may allow more controlled application or application from a device. The composition may be thicked to a viscosity of from 40 to 10,000 cps. Examples of thickened and unthickened compositions can be found in U.S. Pat. No. 6,162,371, U.S. Pat. No. 6,066,614, U.S. Pat. No. 6,153,120, U.S. Pat. No. 6,037,318, U.S. Pat. No. 6,313,082, U.S. Pat. No. 5,688,435, U.S. Pat. No. 6,413,925, U.S. Pat. No. 6,297,209, U.S. Pat. No. 6,100,228, U.S. Pat. No. 5,916,859, U.S. Pat. No. 5,851,421, U.S. Pat. No. 5,688,756, U.S. Pat. No. 5,767,055, U.S. Pat. No. 5,055,219, and U.S. Pat. No. 5,075,029.

The anodic oxidation of chloride in an electrolysis cell results in the production of a number of oxychlorine ions including hypochlorite, chlorite, chlorate, and perchlorate. Chlorite is readily oxidized to chlorate. Perchlorate may be an undesirable contaminant in the environment due to its low reactivity, high mobility, and inhibition of thyroid function. The production of hypochlorite via chlorination of caustic water is not believed to result in the formation of perchlorate. This route may be advantageous for certain uses where minor amounts of perchlorate would be undesirable.

The composition may be prepared by mixing a solid composition with water. The solid composition may be a tablet, granular composition, paste, or other solid composition. The composition may be prepared by diluting a liquid composition with water. The water may be purified. The composition may be prepared by mixing two liquids, for example, from a dual chambered container or a dual chambered spray bottle.

The compositions of the invention can be diluted prior to use with tap water or water of higher purity. Preparation of dilute compositions for storage, for example as pre-diluted in bottles, may require water of higher purity. This higher purity water can be obtained by a variety of processes, including for example, distillation, filtering, sodium cation exchange (soft water), hydrogen cation exchange (deionized water without anion exchange), reverse osmosis, activated carbon treatment, ultrafiltration, nanofiltration, electrodialysis, and UV light treatment.

The compositions of the invention can be diluted prior to use from a concentrated liquid or solid composition. For instance, liquid sodium hypochlorite optionally containing surfactants or other additives of 5.25% available chlorine concentration can be diluted to below 500 ppm available chlorine concentration. Tablets or powders having solid hypochlorite or hypochlorite generators can be dissolved in water to deliver compositions below 500 ppm concentration. Examples of compositions that can be diluted are described in U.S. Pat. No. 6,297,209, U.S. Pat. No. 6,100,228, U.S. Pat. No. 5,851,421, U.S. Pat. No. 5,688,756, U.S. Pat. No. 5,376,297, U.S. Pat. No. 5,034,150, U.S. Pat. No. 6,534,465, U.S. Pat. No. 6,503,877, U.S. Pat. No. 6,416,687, U.S. Pat. No. 6,180,583, and U.S. Pat. No. 6,051,676.

The compositions of the invention can be delivered as part of a multi-compartment delivery system, for example as described in U.S. Pat. No. 5,954,213, U.S. Pat. No. 5,316,159, WO2004/014760, U.S. Pat. No. 6,610,254, and U.S. Pat. No. 6,550,694.

The compositions of the invention can be used to purify water and make the water safe for consumption. The compositions of the invention can be used for a food rinse, for cleaning food-contact surfaces, and for toxicologically safe cleaning. This may involve the use of food-safe ingredients, GRAS ingredients, or ingredients with low toxicological impact. Methods describing this use and possible compositions can be found in U.S. Pat. No. 6,455,086, U.S. Pat. No. 6,313,049, U.S. 2002/0132742, U.S. 2001/0014655, WO99/00025, and U.S. 2002/0151452.

The compositions of the invention can be used to sterilize medical instruments. Dilute hypochlorite will discolor or degrade tubing and other sensitive parts to less extent than concentrated hypochlorite. The compositions may be used in kidney dialysis machines or as an irrigating agent in endodontic treatment. The compositions of the invention can be used to kill tumor cells, affect tumor cell recognition and to induce apoptosis.

The compositions of the invention can be used in agricultural applications, for example, seed and seedling treatments, dormant sprays for fruit trees, stored grain treatments, dips or sprays for any post-harvest plant material and their containers, treatments for soil, either on the land or in containers, treatments for transportation and storage to market, treatments for transportation, storage, and display at market (retail or wholesale), treatments for import and export regulations, and treatments for preventing the accidental introduction of alien pest organisms. The compositions of the invention can be used for the meat, poultry, dairy, seafood, and aquaculture industries, for example, equipment treatments, living quarters treatments, dips or sprays for eggs and containers, dips or sprays for meat and containers, treatments for rendering operations, treatments for transportation and storage to market, treatments for transportation, storage, and display at market (retail or wholesale), treatments for import and export regulations, treatments for preventing alien pest organisms from crossing borders, treating disease on live animals (terrestrial or aquatic), including udder treatments, and dips or sprays for milking equipment, transfer lines, and containers. The compositions of the invention can be used for homeland security, for example, treatments for preventing the intentional introduction of alien pest organisms or deadly human or animal organisms.

The compositions of the invention can be used to preserve and maintain the freshness of freshly cut flowers and other cut plants. The compositions of the invention can be used to prevent the build-up of microorganisms that contribute to the decaying of stems and abscission and scenesing of leaves and flowers. The compositions of the invention can be used to preserve and extend the shelf life of freshly cut fruits and vegetables such as cut melon, cantaloupe, strawberry, potatoes, etc. The compositions of the invention can be used to eradicate hepatitis virus A from fresh strawberries and other fruits and vegetables. The compositions of the invention can be used for in the sprout industry to treat seeds of various plants including alfalfa, wheat, barely and all other edible plant to control the spread of food-borne diseases such as Salmonella, E. coli, Campylobacter, etc. The compositions of the invention can be used in washing and treating shoes that have been moldy. The compositions of the invention can be used with sponges, cheese-cloth, paper towel and other non-woven articles to clean and remove and kill mold, bacteria and viruses from soft and hard surfaces. The compositions of the invention can be used to control mold in school. The compositions of the invention can be used as a spray or wipe product. The compositions of the invention can be used to control the spread of germs on hard surfaces in school. The compositions of the invention can be used to control the spread of hepatitis among jails. The compositions of the invention can be used in laundry to kill germs. The compositions of the invention can be used in long-term care centers and public gyms, where, for example, they can be applied as a spray or wipe product on hard surfaces to kill all germs that are transmitted to environmental surfaces via human activity. The compositions of the invention can be used in laundry to disinfect towels, and other articles that carry germs. The compositions of the invention can be used in public areas where, for example, they can be sprayed on a large scale in parks, streets, public places to control disease-causing agents such as SARS, calicivirus, enterovirus, FMD, and other viruses. The compositions of the invention can be used as wipes or spray to disinfect all environmental surfaces. The compositions of the invention can be used on ships and cruise ships where, for example, they can be used to control the spread of norwalk virus, calicivirus, and influenza virus. The compositions of the invention can be used to control cross contamination due to Salmonella and Campylobacter. The compositions of the invention can be used to protect from biological warfare where, for example, they can be used to spray on humans, (i.e., army personals, medics, etc.) in case of potential presence of biological warfare agents such as Anthrax, BT, Sarin, Small Pox, and SARS, etc. The compositions of the invention can be used for disinfecting military vehicles, airplanes, and others. The compositions of the invention can be used to control the outbreak of infectious agents where, for example, they can be used to disinfect airlines (inside and outside), trains, buses and all sort of transportation means to control the spread of pathogens. The compositions of the invention can be used to disinfect shoes (via a wipe or dipping or spraying) at airports and other ports of entry. The compositions of the invention can be used to control insects where, for example, they can be used as a spray to kill New Zealand Slug and other slugs or insects. The compositions of the invention can be used to kill fleas. The compositions of the invention can be used to control animal and insect pathogens where, for example, they can be used to control animal and bird viruses on hard surfaces and soft surfaces. Such viruses include SARS, bird flu virus, calicivirus, mad cow disease virus, parvovirus, feline viruses, etc. Also, they can be used to dip teats in to control various pathogens.

The composition may be part of an article of manufacture comprising: a container enclosing a liquid composition; a set of instructions; and a liquid composition comprising an allergen neutralizing agent selected from a group consisting of a hypohalous acid, a hypohalous acid salt, and a combination thereof; wherein said set of instructions comprises instructions to contact targets selected from a group consisting of hard surfaces, soft surfaces, or air with said liquid composition in its neat or diluted form to prevent allergic response, to prevent illness, or a combination thereof.

The composition may be part of an article of manufacture wherein said article of manufacture in addition to the usage instructions bears an additional indication comprising a term selected from the group consisting of: healthy, healthier, reduce the occurrence of illness, control the spread of illness in the home, protect your family from illness, keep your home healthier, keep your family well, break the cycle of illness in the home, reduce the risk of common illnesses, and combinations thereof.

The composition may be part of an article of manufacture, wherein said article of manufacture in addition to the usage instructions bears an additional indication comprising a term selected from the group consisting of: neutralizes mold allergens, denatures toxins from mold, neutralizes toxins from mold, neutralizes protein allergens, controls allergens, removes allergens by cleaning, removes allergens by wiping, removes allergens in the laundry, reduces respiratory illness, reduces hay fever, reduces absenteeism, denatures mold allergens, prevents allergenic reactions, prevents allergenic reaction in humans, prevents allergenic symptoms due to mold, kills mold, destroys mold spores, destroys mold spores that cause adverse health effects, proven to prevent mold-triggered allergic sensitization in humans, proven to prevent mold-triggered allergic sensitization in animals, reduces the risk of mold-triggered allergic sensitization, reduces the risk of mold-triggered allergic response, destroys mold spores that induce allergic symptoms, neutralizes mold specific antigens, and prevents non-immune inflammatory reactions to mold.

The composition may be part of an article of manufacture. The article of manufacture may include a set of instructions. The set of instructions may be used with a method of instructing the public by providing to the public a set of instructions for the use of an article of manufacture comprising a container and a liquid composition comprising an allergen neutralizing agent selected from a group consisting of a hypohalous acid, a hypohalous acid salt, and a combination thereof; wherein said set of instructions comprises instructions to contact targets selected from a group consisting of hard surfaces, soft surfaces, or air with said liquid composition in its neat or diluted form to prevent allergic response, to prevent illness, or a combination thereof. The instructions may relate to preventing the spread of illness with a liquid composition comprising a hypohalous acid salt composition. The method of instructing the public may include information that an allergic response represents a response to pollen, dust mite, or mold allergens. The set of instructions may be provided to the public via electronic and/or print media. The set of instructions may be posted at the point of sale adjacent the package. The set of instructions may be posted on a global computer network at an address associated with products from a group consisting of said liquid composition, said target surface, or a combination thereof.

The method of promoting the use of the liquid composition comprising an allergen neutralizing agent selected from a group consisting of a hypohalous acid, a hypohalous acid salt, and a combination thereof may include use instructions to prevent allergic response and/or illness, the method comprising the step of informing the public that the treatment of targets selected from a group consisting of hard surfaces, soft surfaces, or air with said composition reduces and/or prevents allergic response and/or illness. The method of promoting the use of the composition may include the step of informing the consumer via electronic and/or print media.

The use of the composition may include an in vivo test method for testing allergic response in animals, wherein said test method comprises the subcutaneous injection of allergens treated with a composition selected from a group consisting of a hypohalous acid, a hypohalous acid salt, and a combination thereof.

Potential uses for the inventive packaging, compositions, and methods include dishwashing, for example U.S. Pat. Appl. 2003/0216271 to Scheper et al.; hospital environments and medical instruments, for example U.S. Pat. No. 6,632,347 to Buckley et al. and U.S. Pat. No. 6,126,810 to Fricker et al.; wound healing, for example U.S. Pat. Appl. 2003/0185704 to Bernard et al. and U.S. Pat. No. 6,426,066 to Najafi et al.; disinfecting or sterilizing objects such as medical instruments, for example U.S. Pat. No. 6,623,695 to Malchesky et al.; disinfecting and deodorizing the air, for example U.S. Pat. Appl. 2002/0179884 to Hoshino et al.; for water purification, for example U.S. Pat. No. 6,296,744 to Djeiranishvili et al.; removal of mold and mildew, for example U.S. Pat. No. 5,281,280 to Lisowski et al.

### EXAMPLES

During the course of evaluating various oxidants and antimicrobials for their allergen deactivating ability, we have found that a very dilute solution (on the order of 40-80 ppm) of primarily hypochlorous acid can effectively deactivate allergens. Presumably these low levels of oxidant are still able to break up the allergen proteins, rendering them biologically inert.

While effective, the low concentration and nearly neutral pH (6.9) of hypochlorous virtually eliminates damage to surfaces. There is no sticky residue that can affect the feel of fabrics and there may be minimal dye damage. The solution may be aerosolized to treat air directly, or applied to surfaces. Aerosols are known to have a low collision rate between denaturant and allergen particles. As a result, the denaturant must be used in high concentrations to be effective. Using this approach with conventional denaturants, which may be irritating or fragranced at high levels, can cause health problems.

Co-pending application Ser. No. 10/828,571, filed Apr. 20, 2004 discloses factors in the chemical composition that affect the stability of dilute hypohalous acid and hypohalous acid salt compositions, and is incorporated by reference. The stability of these compositions is also affected by packaging and manufacturing materials.

Concentrated hypochlorite bleach is commonly stored in opaque HDPE containers and is not typically compatible with PET containers. Dilute hypochlorite compositions are stable PET containers. The stability of dilute hypochlorite compositions in containers is affected by plastic additives, for example Kemamide® slip agent in polyethylene. The stability of dilute hypochlorite compostions in containers is affected by copolymer blends, for example, acetal copolymers such as Celcon® M90.

It might be expected that opaque monolayer HDPE bottles might protect dilute hypochlorite compostions from sunlight exposure. However, in these HDPE bottles, UV exposure accelerates the degradation of dilute hypochlorite compositions despite a minimal transmission of UV and visible light thru the opaque HDPE bottles. We have found that multilayer bottles with additives in the intermediate or outside layer provide improved stability over single layer bottles. Table I shows stability results of 200 ml HDPE bottles, both multilayer and monolayer, which degraded under UV exposure in the window. The control bottle was kept in the dark.

TABLE I

| | 1 week | 2 weeks | 3 weeks | 4 weeks |
|---|---|---|---|---|
| Control (Trilayer bottle | 100% | 99% | 99% | 96% |
| with virgin resin interior | | | | |
| layer kept in dark) | | | | |
| Monolayer bottle with | 90% | 76% | 68% | 63% |
| colorant-exposed to light | | | | |
| Trilayer bottle with virgin | 97% | 95% | 92% | 87% |
| resin interior layer-exposed | | | | |
| to light | | | | |

Trilayer bottles where the outer layer or intermediate layer has an additive from the group of opacifiers, colorants, and UV inhibitors and where the inner layer has a substantially lower concentration of one of these additives compared to the outer layer or intermediate layer have substantially greater stability compared to bottles where these additives are in the layer that directly contacts the dilute hypochlorite solution. An example of such a trilayer bottle and a bilayer bottle is given in Table II.

TABLE II

| | | |
|---|---|---|
| Bottle type | Extrusion, blow-molded, HDPE | Extrusion, blow- |
| | | molded, HDPE |
| Wall thickness | 30 mils (15% inner layer, 70% | 30 mils (15% inner |
| | middle layer, 15% outer layer) | layer, 85% outer layer) |
| Outer layer | 3% colorant-pigment including | 3% colorant-pigment |
| | titanium dioxide | including titanium |
| | | dioxide |
| Middle layer | 1% colorant, 35% PCR (post- | None |
| | consumer resin) | |
| Inner layer | 0% colorant, virgin resin | 0% colorant, virgin |
| | | resin |

Dilute hypochlorite compositions are UV and light sensitive. UV absorbers that inhibit up to 390 nm can be required for long-term stability in normal store shelf lighting. Light protection up to the 550 nm can be required for direct sunlight exposure through a window. We have found that colorants in plastic bottles affect bleach stability. Therefore, in order to achieve stability from sunlight exposure, a solid color printed on plastic film such as a shrink sleeve or a tinted plastic film such as a shrink sleeve can be used to protect from UV radiation, yet avoid stability problems when the colorant is in the plastic container. One solution to packaging stability of dilute hypochlorite compositons is to use removable printed shrink sleeve that communicates at shelf and then is removed to reveal an aesthetic bottle underneath when peeled away.

We have found that lowering the pH of the formula improves UV stability. The pH of the dilute hypochlorite composition can be lowered from pH 7.5 to pH 5.5 to provide additional stability against UV radiation. The bottles were tested under accelerated testing for 24 hours in the FadeOmeter® at 130° F. with the results in Table III.

TABLE III

| | pH 7.5 | pH 5.5 |
|---|---|---|
| 121 ppm sodium | 56% | 70% |
| hypochlorite in PET bottle | | |
| with UV inhibitor | | |

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself. As such, these changes and modifications are properly, equitably, and intended to be, within the full range of equivalence of the following claims.

1. An article of commerce comprising:
a. a container; and
b. a composition, said composition comprising an oxidant selected from the group consisting of hypohalous acid, hypohalous acid salt, and combinations thereof,
c. wherein said composition has an available chlorine concentration of between 1.0 ppm to about 1200 ppm; and
d. wherein said container comprises a multilayer container comprising:
ii. an inner layer;
iii. an outer layer;
iv. an optional intermediate layer;
e. wherein at least one of said outer layer or said intermediate layer comprises an additive selected from the group consisting of opacifiers, colorants, UV inhibitors and combinations thereof; and
f. wherein said inner layer comprises a substantially lower concentration of one of said additives compared to said outer layer or compared to said optional intermediate layer.

2. The article of commerce of claim 1, wherein said inner layer comprises a thermoplastic material selected from the group consisting of polyethylene terephthalate, polyethylene, and polypropylene

3. The article of commerce of claim 1, wherein said composition has a pH of less than 8.

4. The article of commerce of claim 1, wherein said composition has a pH of less than 7.

5. The article of commerce of claim 1, wherein said composition has a pH of less than 6.

6. The article of commerce of claim 1, wherein said composition has an available chlorine concentration below 500 ppm.

7. An article of commerce comprising:
a. a container;
b. a label; and
c. a composition, said composition comprising an oxidant selected from the group consisting of hypohalous acid, hypohalous acid salt, and combinations thereof,
d. wherein said composition has an available chlorine concentration of between 1.0 ppm to about 1200 ppm; and
e. wherein said label comprises an additive selected from the group consisting of an opacifier, a colorant, a UV inhibitor, and combinations thereof.

8. The article of commerce of claim 7, wherein said additive is uniformly dispersed within the label area.

9. The article of commerce of claim 7, wherein said label is a thermoplastic film.

10. The article of commerce of claim 7, wherein said composition has a pH of less than 8.

11. The article of commerce of claim 7, wherein said composition has a pH of less than 7.

12. The article of commerce of claim 7, wherein said composition has a pH of less than 6.

13. The article of commerce of claim 7, wherein said composition has an available chlorine concentration below 500 ppm.

14. An article of commerce comprising:
a. a container; and
b. a composition,
c. wherein said composition has an available chlorine concentration of between 1.0 ppm to about 1200 ppm; and
d. wherein said container comprises a multilayer container comprising:
i. an inner layer;
ii. an outer layer;
iii. an optional intermediate layer; and
e. wherein at least one of said outer layer or said intermediate layer comprises an additive selected from the group consisting of opacifiers, colorants, UV inhibitors and combinations thereof.

15. The article of commerce of claim 14, wherein said inner layer comprises a thermoplastic material selected from the group consisting of polyethylene terephthalate, high density polyethylene, and polypropylene.

16. The article of commerce of claim 14, wherein said composition has a pH of less than 8.

17. The article of commerce of claim 14, wherein said composition has a pH of less than 7.

18. The article of commerce of claim 14, wherein said composition has a pH of less than 6.

19. The article of commerce of claim 14, wherein said composition has an available chlorine concentration below 500 ppm.

20. The article of commerce of claim 14, wherein said composition comprises an oxidant selected from the group consisting of hypohalous acid, hypohalous acid salt, and combinations thereof.

21. The article of commerce of claim 14, wherein said composition comprises oxidized water.
